(19) United States
(12) Patent Application Publication
(10) Pub. No.: US 2018/0290712 A1
(43) Pub. Date: Oct. 11, 2018

(54) BICYCLE SPROCKET AND BICYCLE SPROCKET ASSEMBLY

(71) Applicant: Shimano Inc., Osaka (JP)

(72) Inventors: Masanori TANIGUCHI, Osaka (JP); Wataru YAMAUCHI, Osaka (JP); Toru IWAI, Osaka (JP); Toyoshi YOSHIDA, Osaka (JP); Dai YOKOZAWA, Osaka (JP)

(21) Appl. No.: 15/906,556

(22) Filed: Feb. 27, 2018

(30) Foreign Application Priority Data
Apr. 5, 2017 (JP) 2017-075416

(51) Int. Cl. B62M 9/12; F16H 55/06; F16H 55/30

(52) U.S. Cl. CPC B62M 9/12; F16H 55/30; F16H 55/06

(57) ABSTRACT

A bicycle sprocket is provided that is configured to limit a chain separation. The bicycle sprocket includes a sprocket body and a plurality of teeth. The sprocket body has a rotational center axis. The plurality of teeth includes a first tooth having a first width extending in a rotational center axis direction, and a second tooth having a second width extending in the rotational center axis direction. The second width is smaller than the first width. The plurality of teeth includes a base body and a nickel plating layer. The nickel plating layer covers at least a portion of the base body. The nickel plating layer includes at least one of phosphorus and boron.

### CROSS-REFERENCE TO RELATED APPLICATIONS

This application claims priority to Japanese Patent Application No. 2017-075416, filed on Apr. 5, 2017. The entire disclosure of Japanese Patent Application No. 2017-075416 is hereby incorporated herein by reference.

### BACKGROUND

### Field of the Invention

The present invention generally relates to a bicycle sprocket and a bicycle sprocket assembly including a bicycle sprocket.

### Background Information

The bicycle sprocket described in US Patent Application Publication No. 2014/0338494 (patent document 1) includes a sprocket body and a plurality of teeth. The teeth include a first tooth having a first width extending in a rotational center axis direction, and a second tooth having a second width extending in a rotational center axis direction, wherein the second width is smaller than the first width.

### SUMMARY

A bicycle sprocket is sometimes formed from aluminum or an aluminum alloy for a weight reduction. The teeth of an aluminum sprocket easily wear due to friction with a chain. As the teeth wear increases, the chain will separate from the sprocket more frequently. Additionally, in a case where the bicycle sprocket includes a shifting area, if the wear advances in teeth arranged outside the shifting area (driving teeth), the chain is easily derailed outside the shifting area during a shifting action. Such a shifting failure causes the chain to fall off.

In accordance with a first aspect of the present invention, a bicycle sprocket includes a sprocket body and a plurality of teeth. The sprocket body has a rotational center axis. The plurality of teeth includes a first tooth having a first width extending in a rotational center axis direction, and a second tooth having a second width extending in the rotational center axis direction. The second width is smaller than the first width. The plurality of teeth includes a base body and a nickel plating layer. The nickel plating layer covers at least a portion of the base body. The nickel plating layer includes at least one of phosphorus and boron.

This structure improves the wear resistance of the teeth and improves the holding power of the chain during driving. Thus, the sprocket limits the separation of the chain for a long period of time.

In accordance with a second aspect of the present invention, a bicycle sprocket includes a sprocket body and a plurality of teeth. The sprocket body has a rotational center axis. The plurality of teeth including a first tooth having a first width extending in a rotational center axis direction, and a second tooth having a second width extending in the rotational center axis direction. The second width is smaller than the first width. The plurality of teeth includes a base body and a nickel plating layer. The nickel plating layer covers at least a portion of the base body. The nickel plating layer includes a hard particle.

This structure improves the wear resistance of the teeth and improves the holding power of the chain during driving. Thus, the sprocket limits the separation of the chain for a long period of time.

In accordance with a third aspect of the present invention, a bicycle sprocket includes a sprocket body and a plurality of teeth. The sprocket body has a rotational center axis. The plurality of teeth at least partially defines at least one shifting area. The plurality of teeth includes a base body and a nickel plating layer. The nickel plating layer covers at least a portion of the base body. The nickel plating layer includes a hard particle.

This structure improves the wear resistance of the teeth and inhibits wear in the driving tooth. This structure limits situations in which an unintended shifting is performed on the driving tooth disposed outside the shifting area.

In accordance with a fourth aspect of the present invention, the bicycle sprocket according to the third aspect is configured so that the plurality of teeth includes a shifting tooth disposed in the shifting area, and a driving tooth disposed in an area different from the shifting area, and the nickel plating layer is formed on at least the driving tooth.

This structure improves the wear resistance of the teeth and inhibits wear in the driving tooth. This structure limits situations in which an unintended shifting is performed on the driving tooth disposed outside the shifting area.

In accordance with a fifth aspect of the present invention, the bicycle sprocket according to the first or second aspect is configured so that each of the plurality of teeth includes a side surface facing in the rotational center axis direction, and the nickel plating layer is formed on the side surface of the first tooth.

This structure inhibits wear in the first tooth (thick tooth) in the rotational center axis direction. Thus, the holding power of the chain is maintained over a long period of time.

In accordance with a sixth aspect of the present invention, the bicycle sprocket according to any one of the first, second, and fifth aspects is configured so that each of the plurality of teeth includes a side surface facing in the rotational center axis direction, and the nickel plating layer is formed on the side surface of the second tooth.

This structure inhibits wear in the second tooth (thin tooth) in the rotational center axis direction. Thus, the holding power of the chain is further maintained over a long period of time.

In accordance with a seventh aspect of the present invention, the bicycle sprocket according to any one of the second, third, and fourth aspects is configured so that the hard particle includes at least one of aluminum oxide and zirconium dioxide.

This structure allows for formation of a nickel plating layer that has a relatively high eutectoid rate for the hard particle.

In accordance with an eighth aspect of the present invention, the bicycle sprocket according to any one of the second, third, fourth, and seventh aspects is configured so that the hard particle has an average particle size that is greater than or equal to 0.8 μm.

In this structure, the average particle size is set to greater than or equal to 0.8 μm. Thus, the amount of wear is drastically reduced.

In accordance with a ninth aspect of the present invention, the bicycle sprocket according to any one of the second, third, fourth, seventh, and eighth aspects is configured so that the hard particle has an area ratio that is greater than or equal to 10% and less than or equal to 30% with respect to a cross section of the nickel plating layer that is parallel to the rotational center axis direction.

In this structure, the area ratio is set to 10% to 30%. Thus, the amount of wear is drastically reduced.

In accordance with a tenth aspect of the present invention, the bicycle sprocket according to any one of the first to ninth aspects is configured so that the base body includes a first layer including a first material, and a second layer including a second material that has a relative density different from a relative density of the first material.

This structure provides a light sprocket while ensuring the strength.

In accordance with an eleventh aspect of the present invention, the bicycle sprocket according to the tenth aspect is configured so that the relative density of the second material is less than the relative density of the first material, and the first layer and the second layer are laminated in the rotational center axis direction.

This structure allows for a weight reduction of the teeth as compared to a case where the first material is included.

In accordance with a twelfth aspect of the present invention, the bicycle sprocket according to the tenth or eleventh aspect is configured so that the first material includes iron, and the second material includes aluminum.

This structure allows for a weight reduction of the bicycle sprocket as compared to a case where only iron is included. Also, the strength of the teeth is increased as compared to a case where only aluminum is included.

In accordance with a thirteenth aspect of the present invention, the bicycle sprocket according to any one of the tenth to twelfth aspects is configured so that the nickel plating layer is formed on an outer surface of the second layer.

This structure improves the wear resistance of the outer surface of the second layer.

In accordance with a fourteenth aspect of the present invention, the bicycle sprocket according to any one of the tenth to thirteenth aspects is configured so that the base body includes a third layer including a third material having a relative density less than the relative density of the first material, and the first layer is formed between the second layer and the third layer in the rotational center axis direction.

In this structure, the center of gravity is located in a middle portion in the rotational center axis direction. This stabilizes rotation of the bicycle sprocket.

In accordance with a fifteenth aspect of the present invention, the bicycle sprocket according to any one of the first to fourteenth aspects is configured so that the nickel plating layer has a Vickers hardness that is greater than or equal to 500 Hv.

This structure inhibits wear in the nickel plating layer as compared to a case where the Vickers hardness of the nickel plating layer is less than 500 Hv.

In accordance with a sixteenth aspect of the present invention, the bicycle sprocket according to any one of the first to fifteenth aspects is configured so that the base body includes aluminum. This structure allows for a weight reduction of the teeth as compared to a case where the base body is formed from only a metal or an alloy having a relative density greater than a relative density of aluminum.

In accordance with a seventeenth aspect of the present invention, the bicycle sprocket according to any one of the first to sixteenth aspects is configured so that each of the plurality of teeth includes a driving surface that transmits driving force to and from a chain, and the nickel plating layer is formed on the driving surface.

This structure improves the wear resistance of the driving surfaces of the plurality of teeth.

In accordance with an eighteenth aspect of the present invention, the bicycle sprocket according to any one of the first to seventeenth aspects is configured so that the nickel plating layer includes at least phosphorus, and the nickel plating layer has a phosphorus content that is greater than or equal to 0.1 mass percent and less than or equal to 10.0 mass percent.

This structure increases the Vickers hardness of the nickel plating layer as compared to a case where the nickel plating layer includes only nickel.

In accordance with a nineteenth aspect of the present invention, the bicycle sprocket according to the eighteenth aspect is configured so that the nickel plating layer has a phosphorus content that is greater than or equal to 1.0 mass percent and less than or equal to 5.0 mass percent.

This structure increases the Vickers hardness of the nickel plating layer as compared to a case where the phosphorus content of the nickel plating layer is less than 1.0 mass percent. Also, the Vickers hardness of the nickel plating layer is increased as compared to a case where the phosphorus content of the nickel plating layer is greater than 5.0 mass percent.

In accordance with a twentieth aspect of the present invention, the bicycle sprocket according to any one of the first to nineteenth aspects is configured so that the nickel plating layer includes at least boron, and the nickel plating layer has a boron content that is greater than or equal to 0.1 mass percent and less than or equal to 10.0 mass percent.

This structure increases the Vickers hardness of the nickel plating layer as compared to a case where the nickel plating layer includes only nickel.

In accordance with a twenty-first aspect of the present invention, the bicycle sprocket according to the twentieth aspect is configured so that the nickel plating layer has a boron content that is greater than or equal to 0.1 mass percent and less than or equal to 2.0 mass percent.

This structure increases the Vickers hardness of the nickel plating layer as compared to a case where the boron content of the nickel plating layer is less than 0.1 mass percent. Also, the Vickers hardness of the nickel plating layer is increased as compared to a case where the boron content of the nickel plating layer is greater than 2.0 mass percent.

In accordance with a twenty-second aspect of the present invention, the bicycle sprocket according to any one of the first to twenty-first aspects is configured so that the nickel plating layer includes electroless nickel plating.

This structure densifies the nickel plating layer and improves the wear resistance of the nickel plating layer.

In accordance with a twenty-third aspect of the present invention, the bicycle sprocket according to any one of the first to twenty-second aspects is configured so that the nickel plating layer has a thickness that is greater than or equal to 1.0 μm and less than or equal to 100 μm. This structure limits exposure of the base body resulting from the wear of the nickel plating layer as compared to a case where the thickness of the nickel plating layer is less than 1.0 μm. Additionally, the time to form the nickel plating layer is shortened as compared to a case where the thickness of the nickel plating layer is greater than 100 μm.

In accordance with a twenty-fourth aspect of the present invention, the bicycle sprocket according to the twenty-third aspect is configured so that the nickel plating layer has a thickness that is greater than or equal to 5.0 μm and less than or equal to 40.0 μm. This structure limits exposure of the base body resulting from the wear of the nickel plating layer as compared to a case where the thickness of the nickel plating layer is less than 5.0 μm. Additionally, the time to form the nickel plating layer is shortened as compared to a case where the thickness of the nickel plating layer is greater than 40.0 μm.

In accordance with a twenty-fifth aspect of the present invention, the bicycle sprocket according to any one of the first to twenty-fourth aspects is configured so that the sprocket body includes a base body including aluminum, and an alumite coating covering at least a portion of the base body.

This structure allows for a weight reduction of the bicycle sprocket as compared to a case where the base body includes only aluminum. Additionally, the alumite coating can be stained in a color that differs from the color of aluminum. This allows the outer appearance to differ from a bicycle sprocket that does not include the alumite coating.

In accordance with a twenty-sixth aspect of the present invention, the bicycle sprocket according to any one of the first to twenty-fifth aspects is configured so that the bicycle sprocket is a single front chain ring.

This structure improves the wear resistance of teeth of the front chain ring.

In accordance with a twenty-seventh aspect of the present invention, a bicycle sprocket assembly includes a first chain ring including the bicycle sprocket according to any one of the first to twenty-sixth aspects and a second chain ring including a further bicycle sprocket that has a smaller diameter than the bicycle sprocket.

This structure improves the wear resistance of teeth of the first chain ring.

In accordance with a twenty-eighth aspect of the present invention, the bicycle sprocket assembly according to the twenty-seventh aspect is configured so that the second chain ring includes a plurality of teeth including a third tooth having a third width in the rotational center axis direction, and a fourth tooth having a fourth width that is smaller than the third width in the rotational center axis direction.

This structure limits the separation of the chain from the second chain ring.

In accordance with a twenty-ninth aspect of the present invention, the bicycle sprocket assembly according to the twenty-eighth aspect is configured so that the third tooth and the fourth tooth each include a base body including aluminum, and an alumite coating covering at least a portion of the base body.

This structure allows for a weight reduction of the second chain ring as compared to a case where the base body includes only aluminum. Also, the alumite coating can be stained in a color that differs from the color of aluminum. This allows the outer appearance to differ from a second chain ring that does not include the alumite coating.

In accordance with a thirtieth aspect of the present invention, the bicycle sprocket assembly according to the twenty-eighth or twenty-ninth aspect is configured so that the third tooth and the fourth tooth each include a base body including aluminum, and electroless nickel plating covering at least a portion of the base body and including at least one of phosphorus and boron.

This structure improves the wear resistance of the third tooth and the fourth tooth of the second chain ring.

The bicycle sprocket and the bicycle sprocket assembly that are described above have a high wear resistance.

### BRIEF DESCRIPTION OF THE DRAWINGS

Referring now to the attached drawings which form a part of this original disclosure.

FIG. 1 is a diagram showing a drivetrain of a bicycle having a front bicycle sprocket and a plurality of rear bicycle sprockets in accordance with a first embodiment.

FIG. 2 is a side elevational view of the front sprocket in accordance with a first embodiment.

FIG. 3 is an edge perspective view of a portion of the front sprocket of the first embodiment.

FIG. 4 is a partially enlarged side elevational view of a portion of the front sprocket of the first embodiment.

FIG. 5 is a plan view of a first tooth of the front sprocket of the first embodiment.

FIG. 6 is a plan view of a second tooth of the front sprocket of the first embodiment.

FIG. 7 is a cross-sectional view of the first tooth of the front sprocket as seen along section line 7-7 in FIG. 5.

FIG. 8 is a cross-sectional view of the second tooth of the front sprocket as seen along section line 8-8 in FIG. 6.

FIG. 9 is a picture showing one example of a second structure of a nickel plating layer taken by an electron microscope.

FIG. 10 is a picture showing another example of the second structure of the nickel plating layer taken by the electron microscope.

FIG. 11 is a side elevational view of a first shifting tooth of the rear sprocket of the second embodiment showing an axial side that faces a smaller diameter sprocket.

FIG. 12 is a plan view of the first shifting tooth of the rear sprocket of the second embodiment.

FIG. 13 is a side elevational view of the first shifting tooth of the rear sprocket of the second embodiment showing an axial side that faces a larger diameter sprocket.

FIG. 14 is a cross-sectional view of a tooth other than the first shifting tooth and a second shifting tooth in the rear sprocket of the second embodiment with an enlarged portion.

FIG. 15 is a side elevational view of a front sprocket assembly have a front sprocket in accordance with a third embodiment.

FIG. 16 is a partially enlarged cross-sectional view of a tooth of the front sprocket shown in FIG. 15.

FIG. 17 is a perspective view of a second shifting tooth of the front sprocket shown in FIG. 15.

FIG. 18 is a cross-sectional view of a first tooth of a front sprocket in accordance with a fourth embodiment.

FIG. 19 is a cross-sectional view of a second tooth of the front sprocket of the fourth embodiment.

FIG. 20 is a cross-sectional view of a first tooth a front sprocket in accordance with of a fifth embodiment.

FIG. 21 is a partially enlarged cross-sectional view of a second tooth of the front sprocket of the fifth embodiment.

FIG. 22 is a partially enlarged cross-sectional view of another embodiment of a nickel plating layer.

FIG. 23 is a cross-sectional view of another embodiment of a nickel plating layer.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

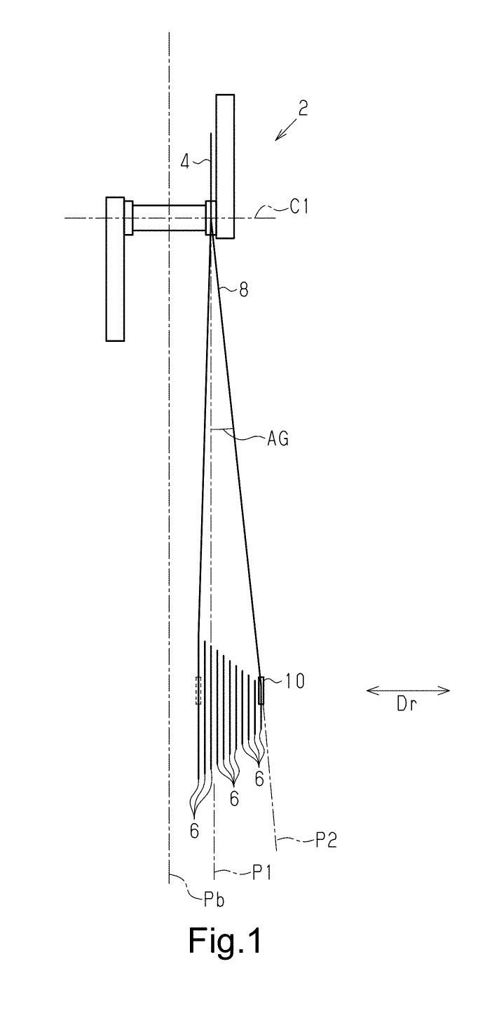

Movement of a chain corresponding to shifting of a bicycle 2 will now be described with reference to FIG. 1. FIG. 1 is a diagram of the bicycle 2 as viewed from above and mainly shows a drivetrain of the bicycle 2. The bicycle 2 includes at least a front sprocket 4, a plurality of rear sprockets 6, a chain 8 and a derailleur 10. The front sprocket 4 is one example of a bicycle sprocket of the present invention. Each of the rear sprockets 6 is another example of a bicycle sprocket of the present invention. The chain 8 runs around the front sprocket 4 and one of the rear sprockets 6, while the derailleur 10 is used to move the chain 8 between the rear sprockets 6 to change the gear ratio of the drivetrain.

In the description of each embodiment, changing of the chain 8 from a certain one of the rear sprockets 6 to one of the rear sprockets 6 having a smaller diameter than the certain rear sprocket 6 is referred to as a “first shift.” Changing of the chain 8 from a certain one of the rear sprockets 6 to one of the rear sprockets 6 having a larger diameter than the certain rear sprocket 6 is referred to as a “second shift.”

In the first shift and the second shift, the derailleur 10 is actuated to move a rear portion of the chain 8 in a rotational center axis direction Dr of the rear sprockets 6. More specifically, in the present embodiment, in the first shift, the rear portion of the chain 8 moves to the right side in the rotational center axis direction Dr (in an outer direction with respect to center plane Pd of bicycle toward the rear sprocket 6 having a smaller diameter). In the second shift, the rear portion of the chain 8 moves to the left side in the rotational center axis direction Dr (toward the rear sprocket 6 having a larger diameter). Thus, an inclination angle AG of the chain 8 varies depending on which one of the rear sprockets 6 engages with the chain 8. The inclination angle AG of the chain 8 refers to an angle formed by a plane P1 including the rotation path of the front sprocket 4 and a plane P2 including a path of the chain 8 that engages with a certain one of the rear sprockets 6. The plane P1 and the plane P2 are orthogonal to a horizontal plane in a state where the bicycle is located in an upright position.

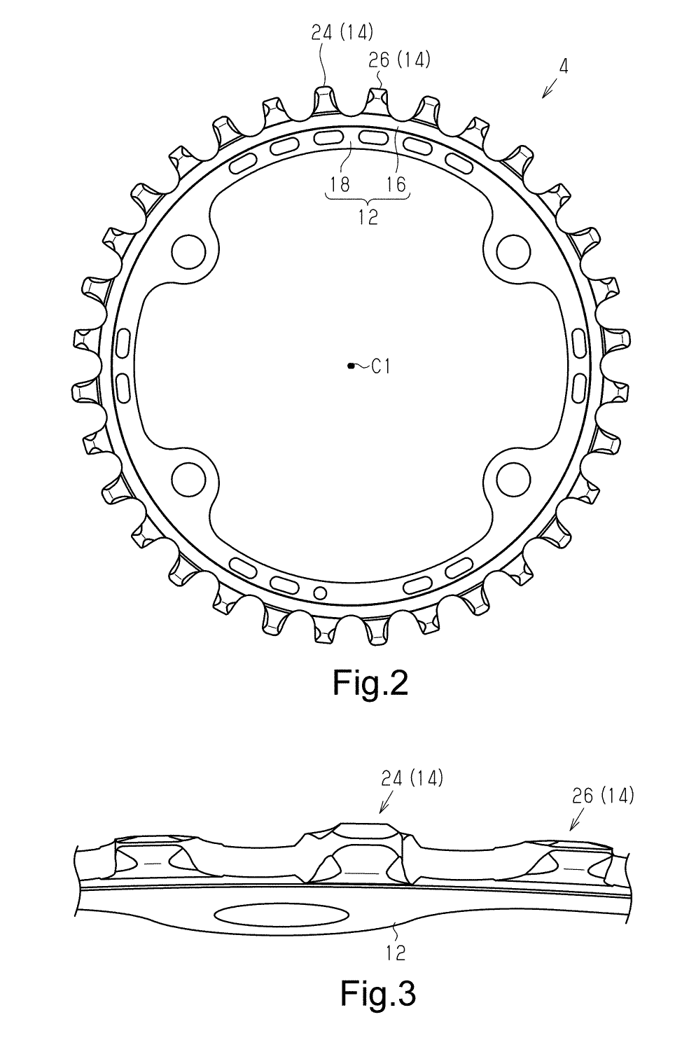

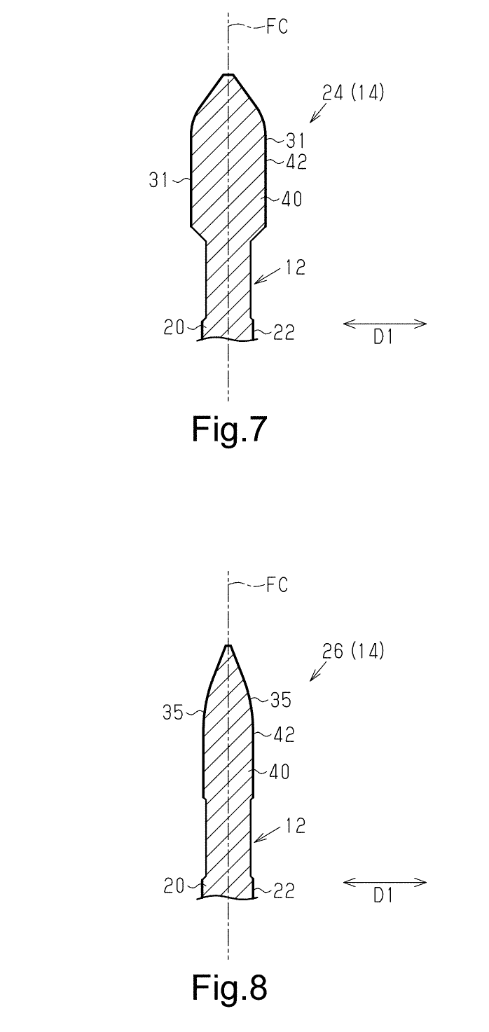

The front sprocket 4 of the present embodiment will now be described with reference to FIGS. 2 and 3. In the present embodiment, the front sprocket 4 is a single front chain ring. The front sprocket 4 includes a sprocket body 12 having a rotational center axis C1 and a plurality of teeth 14. The sprocket body 12 includes a first ring portion 16, which has the rotational center axis C1 of the front sprocket 4, and a second ring portion 18, which is located at an inner side of the first ring portion 16 in a radial direction with respect to the rotational center axis. The sprocket body 12 includes, for example, a base body 20 including aluminum and an alumite coating 22 covering at least a portion of the base body 20 (refer to FIGS. 7 and 8).

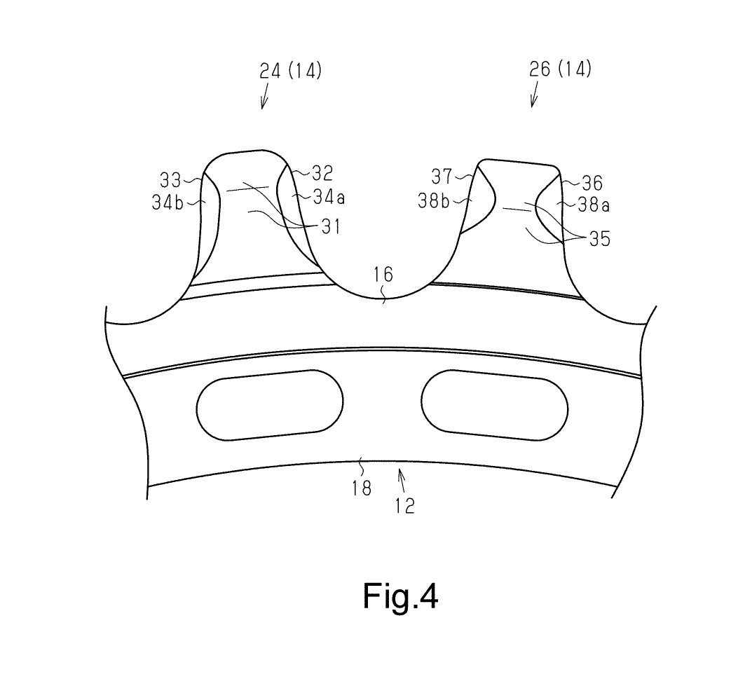

The teeth 14 engage with the chain 8. The teeth 14 project outward from the circumference of the first ring portion 16 in the radial direction with respect to the rotational center axis C1. As shown in FIG. 4, the teeth 14 include at least a first tooth 24 and a second tooth 26. In the present embodiment, the teeth 14 include a plurality of first teeth 24 and a plurality of second teeth 26, which is the same in number as the first tooth 24. The total number of the teeth 14 is even (e.g., 32, 34, 36, or 38). In the present embodiment, the first teeth 24 and the second teeth 26 are alternately arranged in a circumferential direction having a center of which conforms to the rotational center axis C1. The first teeth 24 and the second teeth 26 are arranged at equal pitches. Each of the first teeth 24 engages with a gap between a pair of outer link plates 28 of the chain 8. Each of the second teeth 26 engages with a gap between a pair of inner link plates 30 of the chain 8.

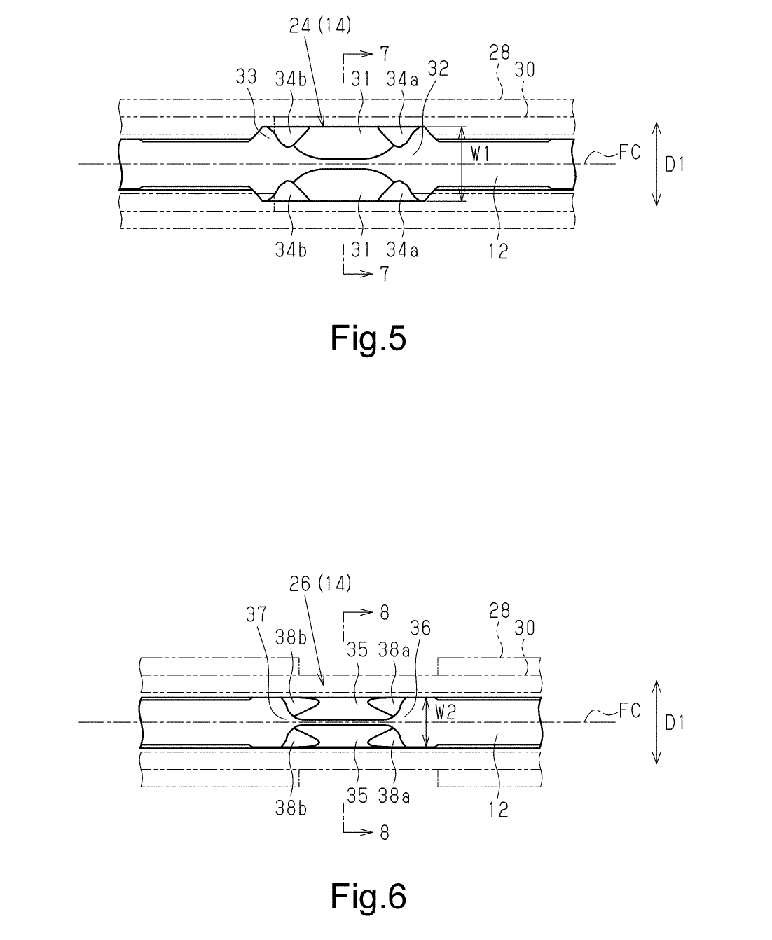

As shown in FIG. 5, the first tooth 24 has a first width W1 extending in a rotational center axis direction D1 that is parallel to the rotational center axis C1. As shown in FIG. 6, the second tooth 26 has a second width W2 extending in the rotational center axis direction D1. The second width W2 is smaller than the first width W1.

The first width W1 indicates a maximum width of the first tooth 24 in the rotational center axis direction D1. The second width W2 indicates a maximum width of the second tooth 26 in the rotational center axis direction D1. The first width W1 is greater than the gap between the pair of the inner link plates 30. Also, the first width W1 is less than the gap between the pair of the outer link plates 28. The second width W2 also less than the gap between the pair of the inner link plates 30.

Each of the plurality of teeth 14 has a side surface 31 facing in the rotational center axis direction D1. The first tooth 24, for example, includes two side surfaces 31, a driving surface 32, a non-driving surface 33, two chamfered surfaces 34a, and two chamfered surfaces 34b. The side surfaces 31 intersect in the rotational center axis direction D1. The driving surface 32 transmits driving force to and from the chain 8. The non-driving surface 33 is opposite to the driving surface 32. The chamfered surfaces 34a are located between the driving surface 32 and each of the side surfaces 31. The chamfered surfaces 34b are located between the non-driving surface 33 and each of the side surfaces 31.

As shown in FIG. 7, in a cross-sectional view taken along a plane that includes the rotational center axis C1, the side surfaces 31 of the first tooth 24 extend outward from the first ring portion 16 in the radial direction with respect to the rotational center axis C1 and parallel to a center plane FC. The side surfaces 31 of the first tooth 24 are also inclined from an intermediate position toward the distal end so as to gradually become closer to the center plane FC. The center plane FC refers to a plane equidistant from the innermost surface and the outermost surface of the first tooth 24 of the sprocket body 12 in the rotational center axis direction D1. As shown in FIG. 6, the second tooth 26 includes two side surfaces 35, a driving surface 36, a non-driving surface 37, two chamfered surfaces 38a and two chamfered surfaces 38b. The side surfaces 35 intersect in the rotational center axis direction D1. The driving surface 36 transmits driving force to and from the chain 8. The non-driving surface 37 is opposite to the driving surface 36. The two chamfered surfaces 38a are located between the driving surface 36 and each of the side surfaces 35. The two chamfered surfaces 38b are located between the non-driving surface 37 and each of the side surfaces 35.

As shown in FIG. 8, in a cross-sectional view taken along a plane that includes the rotational center axis C1, the side surfaces 35 of the second tooth 26 extend outward from the first ring portion 16 in the radial direction with respect to the rotational center axis C1 and parallel to the center plane FC. The side surfaces 35 of the second tooth 26 are also inclined from an intermediate position toward the distal end so as to gradually become closer to the center plane FC.

Engagement of the first tooth 24 and the second tooth 26 with the chain 8 will now be described with reference to FIGS. 5 and 6. FIGS. 5 and 6 do not show roller pins of the chain 8. As shown in FIGS. 5 and 6, in a state where the chain 8 engages the front sprocket 4, the inner link plates 30 of the chain 8 are each located between two of the first teeth 24 that are adjacent to each other in a circumferential direction with respect to the rotational center axis C1. The inner surface of each of the inner link plates 30 of the chain 8 is located closer to the center surface FC than the thickest portion of each of the first teeth 24 in the rotational center axis direction D1. Since the first width W1 of the first tooth 24 is configured to be greater than the gap between the pair of the inner link plates 30, the side surfaces 31 are located in the proximity of the inner surfaces of the outer link plates 28. Thus, the chain 8 engages the teeth 14 so as to reduce the gap between the chain 8 and the teeth 14 in an axial direction. This hinders separation of the chain 8 from the front sprocket 4 during driving.

Wear of the teeth 14, which relates to the substances forming the teeth 14, will now be described with reference to FIG. 1. As described above, the inclination angle AG of the chain 8 relative to the front sprocket 4 varies in accordance with the position of the rear sprocket 6 that engages with the chain 8. As the inclination angle AG of the chain 8 increases, the pressure of contact increases between the outer link plates 28 of the chain 8 and the first teeth 24 and between the inner link plates 30 of the chain 8 and the second teeth 26. This can advance wear in the first teeth 24 and the second teeth 26. In particular, the side surfaces 31 of the first teeth 24 contact the outer link plates 28. Thus, wear can increase in the side surfaces 31 of the first teeth 24. Also, the side surfaces 35 of the second teeth 26 contact the inner link plates 30. Thus, wear can increase in the side surfaces 35 of the second teeth 26. Additionally, in a case where a front sprocket is formed from aluminum or an aluminum alloy for weight reduction, the front sprocket wears more than a front sprocket formed from a material having a relatively high wear resistance such as iron. If the amount of wear is large, then the gap between the chain 8 and each of the first teeth 24 and the second teeth 26 becomes larger in the axial direction. This lowers the holding power of the chain 8 during driving and causes more frequent separations of the chain.

In this regard, the teeth 14 of the present embodiment have a structure described below (hereafter, referred to as “the first structure”). As shown in FIGS. 7 and 8, each of the teeth 14 includes a base body 40 and a nickel plating layer 42. The nickel plating layer 42 covers at least a portion of the base body 40. The nickel plating layer 42 includes at least one of phosphorus and boron. Preferably, the base body 40 includes aluminum. The material of the base body 40 is, for example, an aluminum alloy. The term “the plurality of teeth” refers to two or more teeth selected from a group of the plurality of the first teeth and the plurality of the second teeth of the front sprocket. In other words, the term “the plurality of teeth” does not necessarily include all of the first teeth and the second teeth of the front sprocket. In the present embodiment, the front sprocket 4 includes only the plurality of the first teeth 24 and the plurality of the second teeth 26. However, in other embodiment, the front sprocket 4 can have teeth in addition to the first teeth 24 and the second teeth 26.

The nickel plating layer 42 is partially or entirely formed on surfaces of the first tooth 24 and the second tooth 26. The nickel plating layer 42 is, for example, formed on the side surfaces 31 of the first tooth 24. Also, the nickel plating layer 42 is, for example, formed on the side surfaces 35 of the second tooth 26. Additionally, the nickel plating layer 42 can be formed on the driving surface 32 of the first tooth 24. Also, the nickel plating layer 42 can be formed on the driving surface 36 of the second tooth 26. Further, the nickel plating layer 42 can be formed on the chamfered surfaces 34a, 34b of the first tooth 24. Also, the nickel plating layer 42 can be formed on the chamfered surfaces 38a, 38b of the second tooth 26.

The nickel plating layer 42 includes at least one of phosphorus and boron. This increases Vickers hardness as compared to a case where these elements are not included. Preferably, the Vickers hardness of the nickel plating layer 42 is greater than or equal to 500 Hv.

For example, in a case where the nickel plating layer 42 includes phosphorus, the phosphorus content of the nickel plating layer 42 is greater than or equal to 0.1 mass percent and less than or equal to 10.0 mass percent. More preferably, the phosphorus content of the nickel plating layer 42 is greater than or equal to 1.0 mass percent and less than or equal to 5.0 mass percent. In a case where the nickel plating layer 42 includes boron, it is preferred that the boron content of the nickel plating layer 42 be greater than or equal to 0.1 mass percent and less than or equal to 10.0 mass percent. It is more preferable that the boron content of the nickel plating layer 42 be greater than or equal to 0.1 mass percent and less than or equal to 2.0 mass percent.

Preferably, the nickel plating layer 42 includes electroless nickel plating. The thickness of the nickel plating layer 42 is greater than or equal to 1.0 μm and less than or equal to 100 μm. More preferably, the thickness of the nickel plating layer 42 is greater than or equal to 5.0 μm and less than or equal to 40.0 μm.

The operation of the first structure will now be described. The front sprocket 4 includes the first teeth 24 and the second teeth 26. The second width W2 of each of the second teeth 26 is smaller than the first width W1 of each of the first teeth 24. In the front sprocket 4 described above, the second teeth 26 tend to contact the inner link plates 30 of the chain 8. Also, the first teeth 24 tend to contact the outer link plates 28 of the chain 8. In particular, as the inclination angle of the chain 8 increases, the contact occurs more frequently and the pressure of contact increases. In a case where the frequency of contact and the pressure of contact are high, the amount of wear in the first teeth 24 and the second teeth 26 increases. As the wear advances in the first teeth 24 and the second teeth 26, the gaps between the first teeth 24 and the pair of the outer link plates 28 are enlarged. Thus, the chain separation easily occurs. Also, the gaps between the second teeth 26 and the pair of the inner link plates 30 are enlarged. Thus, the chain separation easily occurs.

The teeth of the front sprocket 4 of the present embodiment have the first structure. In the first structure described above, at least two teeth selected from the group of the plurality of teeth 14, including the first teeth 24 and the second teeth 26, include the base body 40 and the nickel plating layer 42 covering at least a portion of the base body 40. The nickel plating layer 42 include at least one of phosphorus and boron. Phosphorus contributes to improvement in the hardness of the nickel plating layer 42. Also, boron contributes to improvement in the hardness of the nickel plating layer 42. Thus, the above structure improves the wear resistance of the teeth 14. Accordingly, the holding power of the chain 8 is improved during driving, and the chain separation is limited for a long period of time.

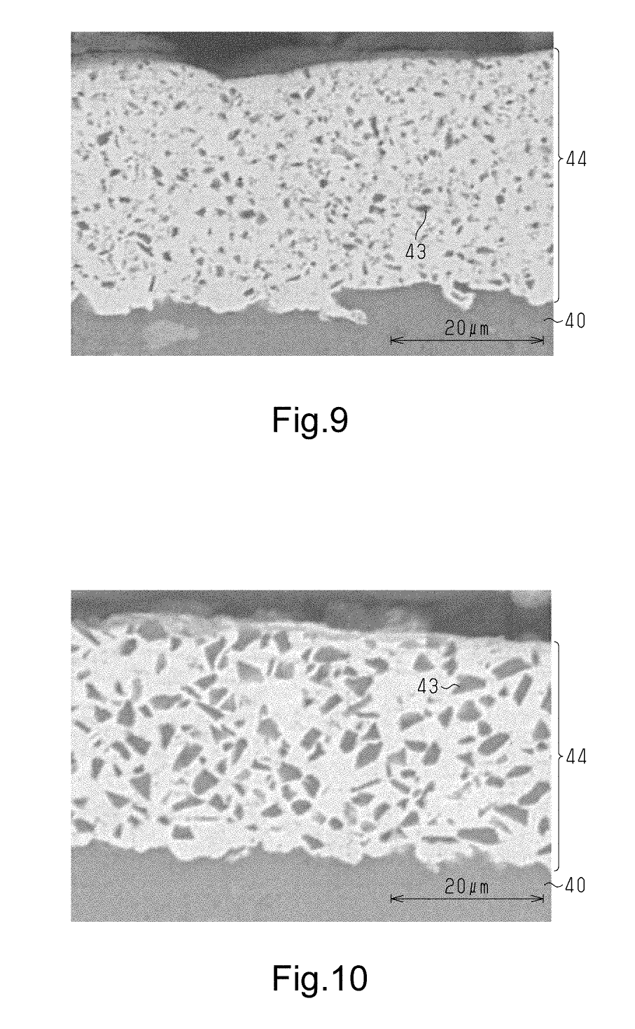

Another structure (hereafter, referred to as “the second structure”) of substances forming the first teeth 24 will now be described with reference to FIGS. 9 and 10. The plurality of teeth 14 includes the base body 40 and a nickel plating layer 44 covering at least a portion of the base body 40, and including hard particles 43. Preferably, the base body 40 includes aluminum. The material of the base body 40 is, for example, an aluminum alloy. The hard particles 43 are dispersed in the nickel plating. The plurality of teeth 14 refers to two or more teeth selected from a group of the plurality of first teeth 24 and the plurality of second teeth 26 of the front sprocket 4.

The nickel plating layer 44 is partially or entirely formed on surfaces of the first tooth 24 and the second tooth 26. The nickel plating layer 44 is, for example, formed on the side surfaces 31 of the first tooth 24. Also, the nickel plating layer 44 is, for example, formed on the side surfaces 35 of the second tooth 26. Additionally, the nickel plating layer 44 can be formed on the driving surface 32 of the first tooth 24. Also, the nickel plating layer 44 can be formed on the driving surface 36 of the second tooth 26. Further, the nickel plating layer 44 can be formed on the chamfered surfaces 34a and 34b of the first tooth 24. Also, the nickel plating layer 44 can be formed on the chamfered surfaces 38a and 38b of the second tooth 26.

The nickel plating layer 44 includes the hard particles 43. The hard particles 43 have a higher Vickers hardness than the nickel plating layer 44, which is formed by nickel plating. The hard particles 43 include at least one of aluminum oxide and zirconium dioxide. Additionally, the hard particles 43 can include other ceramics such as silicon carbide or silicon nitride. Preferably, the Vickers hardness of the hard particles 43 is greater than or equal to 1000 Hv. Preferably, the average particle size of the hard particles 43 is greater than or equal to 0.8 μm. The average particle size of the hard particles 43 is, more preferably, greater than or equal to 0.8 μm and less than or equal to 3.0 μm, and further preferably, greater than or equal to 0.8 μm and less than or equal to 2.0 μm. The average particle size refers to median size D50. FIG. 9 shows an example of the nickel plating layer 44 including the hard particles 43 of aluminum oxide where D50 is 1.2 μm. FIG. 10 shows an example of the nickel plating layer 44 including the hard particles 43 of aluminum oxide where D50 is 3.0 μm.

Preferably, the hard particles 43 have an area ratio that is greater than or equal to 10% and less than or equal to 30% with respect to a cross section of the nickel plating layer 44 that is parallel in the rotational center axis direction D1. More preferably, the area ratio is greater than or equal to 10% and less than or equal to 15%. The area ratio refers to the ratio of the area occupied by the hard particles 43 to the area of a predetermined region in the cross section of the nickel plating layer 44.

Preferably, the nickel plating layer 44 having such a configuration has a Vickers hardness that is greater than or equal to 500 Hv. The nickel plating layer 44 can include at least one of phosphorus and boron. For example, in a case where the nickel plating layer 44 includes phosphorus, the phosphorus content of the nickel plating layer 44 is greater than or equal to 0.1 mass percent and less than or equal to 10.0 mass percent. More preferably, the phosphorus content of the nickel plating layer 44 is greater than or equal to 1.0 mass percent and less than or equal to 5.0 mass percent.

In a case where the nickel plating layer 44 includes boron, it is preferred that the boron content of the nickel plating layer 44 be greater than or equal to 0.1 mass percent and less than or equal to 10.0 mass percent. More preferably, the boron content of the nickel plating layer 44 is greater than or equal to 0.1 mass percent and less than or equal to 2.0 mass percent.

Preferably, the nickel plating layer 44 includes electroless nickel plating. The thickness of the nickel plating layer 44 is greater than or equal to 1.0 μm and less than or equal to 100 μm. More preferably, the thickness of the nickel plating layer 44 is greater than or equal to 5.0 μm and less than or equal to 40.0 μm.

The operation of the second structure will now be described. In case where the front sprocket 4 includes the first tooth 24 and the second tooth 26 that have different widths in the rotational center axis direction D1, the front sprocket 4 wears and the chain separation easily occurs as described above. This point has been described.

In the second structure, at least two teeth selected from the group of the plurality of teeth 14, including the first teeth 24 and the second teeth 26, include the base body 40 and the nickel plating layer 44. The nickel plating layer 44 covers at least a portion of the base body 40 and includes the hard particles 43. The hard particles 43 contribute to improvement in the hardness of the nickel plating layer 44. Thus, the above structure improves the wear resistance of the teeth. Accordingly, the holding power of the chain 8 is improved during driving. This provides a sprocket that limits a chain separation for a long period of time.

### Second Embodiment

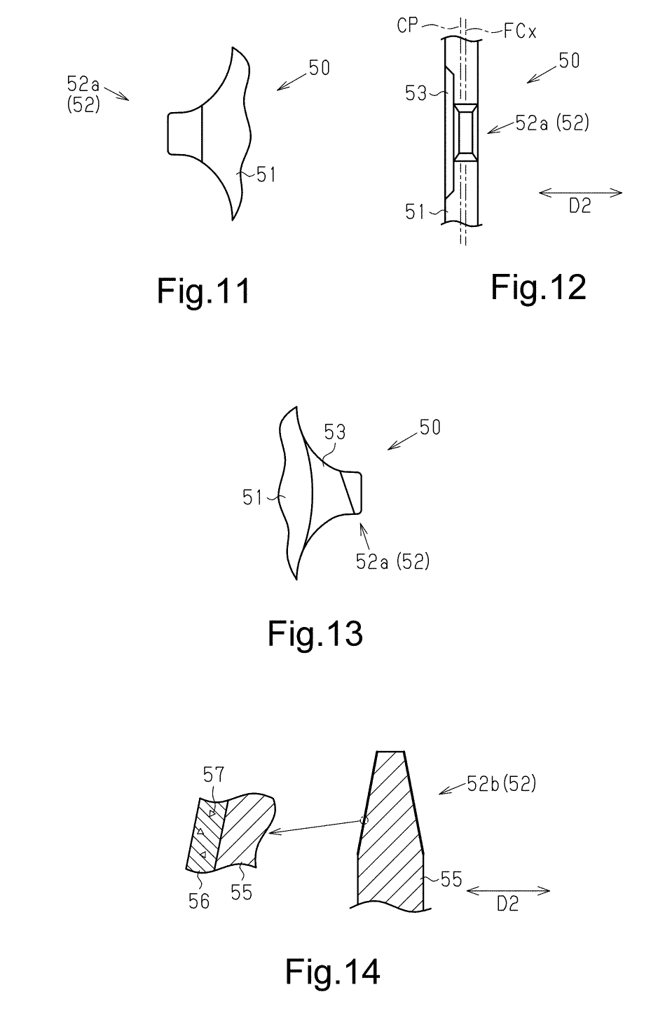

Rear sprockets 50 of the present embodiment will now be described with reference to FIGS. 11 to 14. The rear sprockets 50 are each one example of a bicycle sprocket. The rear sprockets 50 (bicycle sprockets) each include a sprocket body 51 and a plurality of teeth 52. The sprocket body 51 has a rotational center axis. Here, the plurality of teeth 52 define at least one shifting area. The sprocket body 51 has a base body that can include aluminum. As shown in FIG. 14, the plurality of teeth 52 includes a base body 55 and a nickel plating layer 56. The nickel plating layer 56 covers at least a portion of the base body 55 and includes hard particles 57. Preferably, the base body 55 includes aluminum. The material of the base body 55 is, for example, an aluminum alloy. The hard particles 57 can be the same as those of the above embodiment.

The plurality of teeth 52 includes a first shifting tooth 52a, a second shifting tooth (not shown) and another tooth 52b. The shifting area includes at least the first shifting tooth 52a and the second shifting tooth (not shown). The first shifting tooth 52a has a shape (chamfer or recess) that facilitates the first shift of the chain 8. The second shifting tooth has a shape that facilitates the second shift of the chain 8.

As shown in FIGS. 12 and 13, the first shifting tooth 52a includes a recess 53 as the shape facilitating the shift. The first shifting tooth 52a has a center plane FCx perpendicular to a rotational center axis direction D2. The center plane FCx is offset from a center plane CP bisecting the sprocket body 51 to an outer side of the rear sprockets 50 (toward smaller diameter sprockets) in the rotational center axis direction D2. The recess 53 of the first shifting tooth 52a is located on a large diameter sprocket side that faces toward a larger diameter one of the rear sprockets (toward hub) in a direction in which the rear sprockets 50 are arranged. The recess 53 defines a cavity allowing for insertion of the inner link plates 30 of the chain 8.

With this structure, in a case the derailleur 10 applies force to the chain 8 from a small diameter sprocket side, the inner link plates 30 of the chain 8 enter the recess 53. The first shifting tooth 52a that is moved closer to the smaller diameter sprocket moves the chain 8 toward the smaller diameter sprocket. Also, in this state, the inner link plates 30 contact a wall of the recess 53, and the chain 8 is assisted toward the smaller diameter sprocket. Consequently, the chain 8 smoothly performs the first shift.

The structures forming another tooth 52b (hereafter, referred to as “the driving tooth”), which differs from the first shifting tooth 52a and the second shifting tooth (not shown), will now be described. The driving tooth 52b functions as a driving tooth that drives the chain 8. The wall of the recess 53 of the first shifting tooth 52a comes into contact with the inner link plates 30 of the chain 8 to guide the inner link plates 30 of the chain 8 toward the smaller diameter sprocket. The driving tooth 52b transmits force to the chain 8. If wear occurs in the driving tooth 52b, then shifting is more likely to be performed in a region other than the teeth (e.g., first shifting tooth 52a) included in the shifting area.

In the present embodiment, the nickel plating layer 56 is formed on at least the driving tooth 52b. Instead, the nickel plating layer 56 can be formed on all of the plurality of teeth 52 including the first shifting tooth 52a and the driving tooth 52b. The nickel plating layer 56 has the second structure as described in the first embodiment. Instead, the nickel plating layer 56 can be configured to have the first structure. This inhibits wear in the plurality of teeth 52b (driving teeth) caused by contact with the chain 8. Thus, the wear resistance of the teeth 52b (driving teeth) is improved. Inhibition of wear in the plurality of teeth 52b (driving teeth) other than the first shifting tooth 52a and the second shifting tooth limits situations in which an unintended shifting is performed on the teeth 52b (driving teeth) disposed outside the shifting area.

### Third Embodiment

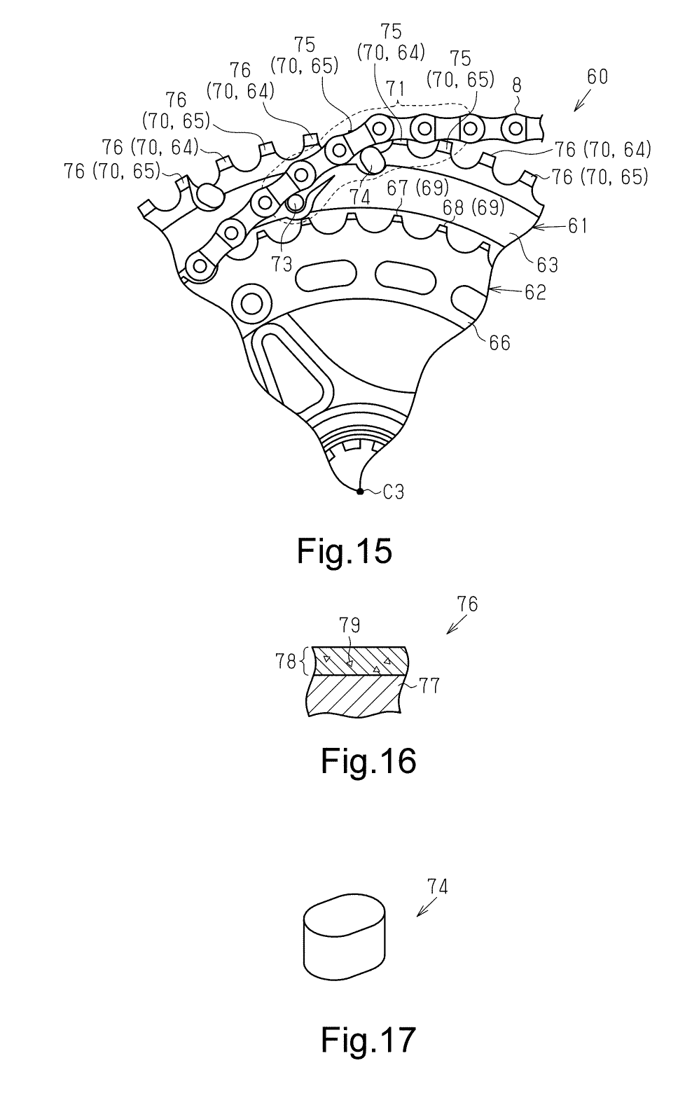

The present embodiment of a front sprocket assembly will now be described with reference to FIG. 15. The front sprocket assembly is one example of a bicycle sprocket assembly.

A front sprocket assembly 60 includes a first chain ring 61 and a second chain ring 62, which has a smaller diameter than the first chain ring 61. The second chain ring 62 and the first chain ring 61 have a common rotational center axis C3.

The first chain ring 61 includes a sprocket body 63 and a plurality of teeth 70. The sprocket body 63 has the rotational center axis C3. The plurality of teeth 70 includes a plurality of first teeth 64 and a plurality of second teeth 65. The first teeth 64 each has a first width extending in the rotational center axis direction. The second teeth 65 each has a second width extending in the rotational center axis direction. The second width is smaller than a first width. The structure of the first teeth 64 conforms to the structure of the first embodiment. The structure of the second teeth 65 conforms to the structure of the first embodiment. The first teeth 64 have, for example, the first structure or the second structure. Also, the second teeth 65 have the first structure or the second structure.

The second chain ring 62 includes a sprocket body 66 and a plurality of teeth 69. The plurality of teeth 69 includes a plurality of third teeth 67 and a plurality of fourth teeth 68. The plurality of third teeth 67 each has a third width extending in the rotational center axis direction. The plurality of fourth teeth 68 each has a fourth width extending in the rotational center axis direction. The fourth width is smaller than the third width. The third teeth 67 and the fourth teeth 68 each include a base body including aluminum and an alumite coating (not shown) covering at least a portion of the base body. Alternatively, the third teeth 67 and the fourth teeth 68 can each include a base body including aluminum and electroless nickel plating, which covers at least a portion of the base body and includes at least one of phosphorus and boron. The material of the base bodies of the third teeth 67 and the fourth teeth 68 is, for example, an aluminum alloy.

In a case where at least one of the plurality of the third teeth 67 and the plurality of the fourth teeth 68 includes an alumite coating and electroless nickel plating that includes at least one of phosphorus and boron, the alumite coating and the electroless nickel plating are formed on different portions of the base bodies. For example, the alumite coating is formed on the side surfaces of the third teeth 67 and the side surfaces of the fourth teeth 68. The electroless nickel plating including at least one of phosphorus and boron is formed on the driving surfaces of the third teeth 67 and the driving surfaces of the fourth teeth 68.

As shown in FIGS. 15 to 17, the first chain ring 61 can include the sprocket body 63 having the rotational center axis C3 and the plurality of teeth 70, wherein at least one shifting area 71 is defined by at least one of the sprocket body 63 and the plurality of teeth 70. Here, one of the shifting areas 71 is defined by a portion of the sprocket body 63 and three of the plurality of teeth 70.

The plurality of teeth 70 includes a plurality (three) shifting teeth 75 disposed in the shifting area 71, and a plurality driving teeth 76 disposed in an area different from the shifting area 71. The shifting teeth 75 include a tooth disposed at the same position as a second spike pin 74 and a pair of teeth disposed at a rear side (upstream) of the second spike pin 74 in a circumferential direction with respect to the rotational center axis C3. The shifting teeth 75 include a tooth that first engages the chain 8 in a case of shifting the chain 8 from the second chain ring 62 toward the first chain ring 61. A nickel plating layer 78 is formed on at least the driving teeth 76. Preferably, the base bodies of the driving teeth 76 include aluminum. The material of the base bodies of the driving teeth 76 is an aluminum alloy. The structure of the nickel plating layer 78 conforms to that described in the first embodiment. The nickel plating layer 78 can have, for example, the first structure or the second structure. As shown in FIG. 16, the plurality of driving teeth 76 includes, for example, a base body 77 and the nickel plating layer 78. The nickel plating layer 78 covers at least a portion of the base body 77 and includes hard particles 79.

The first chain ring 61 includes two shifting spike pins (hereafter, referred to as first spike pin 73 and second spike pin 74). The first spike pin 73 and the second spike pin 74 are included in the shifting area. The first spike pin 73 is configured to be a cylinder. In a case of shifting the chain 8 from the second chain ring 62 to the first chain ring 61, the chain 8 is supported by a side surface of the first spike pin 73.

As shown in FIG. 17, the second spike pin 74 is configured to be an oblong cylinder. In a case of shifting the chain 8 from the second chain ring 62 to the first chain ring 61, the chain 8 is supported by a curved side surface of the second spike pin 74.

The first spike pin 73 is arranged on the first chain ring 61 at an outer side of the outer circumference of the second chain ring 62 in a radial direction with respect to the rotational center axis C3. The second spike pin 74 is located at an outer side of the first spike pin 73 in the radial direction with respect to the rotational center axis C3. The first spike pin 73 and the second spike pin 74 are located at an outer side of the rotational center axis C3 (toward second chain ring 62). During shifting, the first spike pin 73 and the second spike pin 74 assist in shifting of the chain 8 from the second chain ring 62 to the first chain ring 61.

The operation of the front sprocket assembly 60 of the present embodiment will now be described. If the driving teeth 76 of the first chain ring 61 wear, the chain 8 is easily caught by the worn portion or can be derailed. This causes unintended shifting (first shift or second shift) to be performed outside the shifting area 71 and the chain to fall off from the front sprocket assembly 60.

The driving teeth 76 of the present embodiment are at least partially covered by the nickel plating layer 78. The nickel plating layer 78 includes the hard particles 79. Although the nickel plating layer 78 is formed on at least the driving teeth 76, the nickel plating layer 78 can be formed on all of the plurality of teeth 70. The hard particles 79 contribute to improvement in the hardness of the nickel plating layer 78. Therefore, the above structure improves the wear resistance of the driving teeth 76 and inhibits wear of the driving teeth 76. This structure limits situations in which an unintended shifting is performed on the driving teeth 76 disposed outside the shifting area 71.

### Fourth Embodiment

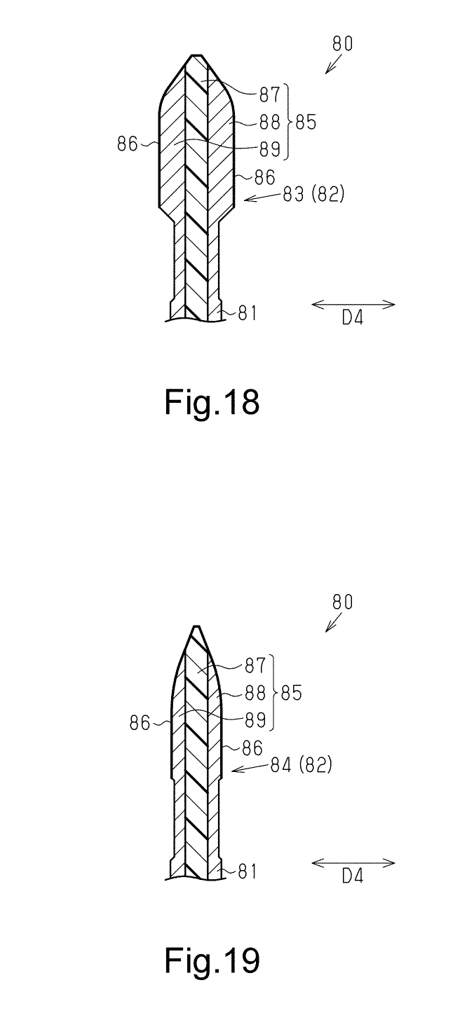

The present embodiment of a front sprocket 80 will now be described with reference to FIGS. 18 and 19. The front sprocket 80 includes a sprocket body 81 and a plurality of teeth 82. The plurality of teeth 82 includes a first tooth 83 and a second tooth 84. The shape of the first tooth 83 conforms to the shape of the first tooth 24 described in the first embodiment. The shape of the second tooth 84 conforms to the shape of the second tooth 26 described in the first embodiment. Preferably, in the present embodiment, the front sprocket 80 has the same shape as shown in FIG. 4 with a plurality of the first teeth 83 and a plurality of the second teeth 84 are alternately arranged in a circumferential direction around a center of which conforms to a rotational center axis.

The plurality of teeth 82 includes a base body 85 and a nickel plating layer 86. The nickel plating layer 86 can have the first structure or the second structure, which are described in the first embodiment. The base body 85 includes a first layer 87, a second layer 88 and a third layer 89. The first layer 87 includes a first material. The second layer 88 includes a second material having a relative density different from a relative density of the first material. The third layer 89 includes a third material having a relative density less than the relative density of the first material. Preferably, the relative density of the second material is less than the relative density of the first material.

The first layer 87 and the second layer 88 are laminated in a rotational center axis direction D4. The second layer 88 and the third layer 89 are laminated in the rotational center axis direction D4. The first layer 87 is formed between the second layer 88 and the third layer 89 in the rotational center axis direction D4.

The first material includes, for example, iron. The first material is, for example, various kinds of steel materials such as stainless steel. The second material includes aluminum. The third material includes aluminum. The nickel plating layer 86 is formed on an outer surface of the second layer 88. Additionally, the nickel plating layer 86 can be formed on an outer surface of the third layer 89. This structure allows for a weight reduction of the plurality of teeth 82 and inhibits wear in the layers including aluminum.

### Fifth Embodiment

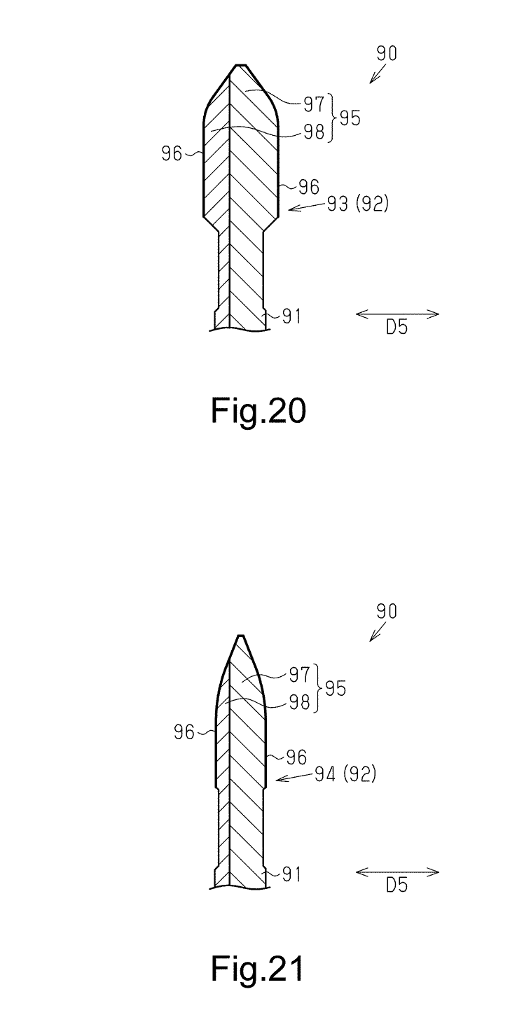

The present embodiment of a front sprocket 90 will now be described with reference to FIGS. 20 and 21. The front sprocket 90 includes a sprocket body 91 and a plurality of teeth 92. The plurality of teeth 92 includes a first tooth 93 and a second tooth 94. The shape of the first tooth 93 conforms to the shape of the first tooth 24 described in the first embodiment. The shape of the second tooth 94 conforms to the shape of the second tooth 26 described in the first embodiment. Preferably, in the present embodiment, the front sprocket 90 has the same shape as shown in FIG. 4 with a plurality of the first teeth 93 and a plurality of the second teeth 94 are alternately arranged in a circumferential direction around a center of which conforms to a rotational center axis.

The plurality of teeth 92 includes a base body 95 and a nickel plating layer 96. The nickel plating layer 96 can have the first structure or the second structure, which are described in the first embodiment. The base body 95 includes a first layer 97 and a second layer 98. The first layer 97 includes a first material. The second layer 98 includes a second material having a relative density different from a relative density of the first material. Preferably, the relative density of the second material is less than the relative density of the first material.

The first layer 97 and the second layer 98 are laminated in a rotational center axis direction D5. The first material includes, for example, iron. The first material is, for example, various kinds of steel materials such as stainless steel. The second material includes aluminum. The nickel plating layer 96 is formed on an outer surface of the second layer 98. This structure allows for a weight reduction of the plurality of teeth 92 and inhibits wear in the layer including aluminum.

### Modifications

The above description illustrates embodiments of a bicycle sprocket and is not intended to be restrictive. In addition to the above embodiments, the present invention includes embodiments having modifications described below. Further, two or more of the modifications can be combined in a single embodiment.

The nickel plating layer of each embodiment can include elements other than phosphorus and boron. The amounts of elements other than phosphorus and boron included in the nickel plating layer can be set within a range that will not decrease the hardness of the nickel plating layer, preferably, a range that will not decrease the hardness of the nickel plating layer to 500 Hv or below.

In each embodiment, an adhesive layer can be formed between the nickel plating layer and the base body. Preferably, the adhesive layer is a metal layer that adheres to both of the base body and the nickel plating layer.

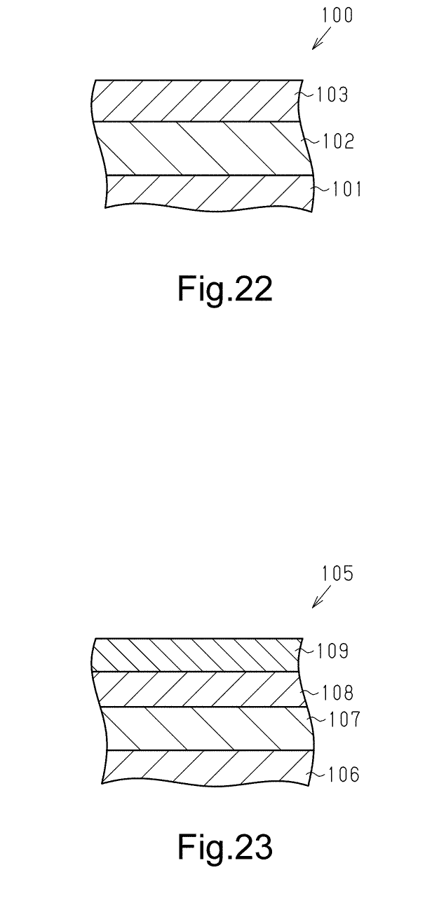

As shown in FIG. 22, each embodiment can include a nickel plating layer 100 having a two-layer structure. The nickel plating layer 100 includes, for example, a first nickel plating layer 101, which is formed on a base body 101, and a second nickel plating layer 103, which is formed on the first nickel plating layer 102. Additionally, an electroless nickel plating layer or another metal plating layer can be formed on an outer surface of the second nickel plating layer 103.

In one example, the first nickel plating layer 102 is a layer that does not include phosphorus and boron. The second nickel plating layer 103 has the first structure. In one example, the first nickel plating layer 102 is a layer that does not include phosphorus and boron. The second nickel plating layer 103 has the second structure. In one example, the first nickel plating layer 102 has the first structure. The second nickel plating layer 103 has the second structure. In one example, the first nickel plating layer 102 has the second structure. The second nickel plating layer 103 has the first structure. In one example, the first nickel plating layer 102 is an electroless nickel plating layer. The second nickel plating layer 103 has the first structure. In one example, the first nickel plating layer 102 is an electroless nickel plating layer. The second nickel plating layer 103 has the second structure.

As shown in FIG. 23, a nickel plating layer 105 can have a three-layer structure. More specifically, the nickel plating layer 105 includes a first nickel plating layer 107, which is formed on a base body 106, a second nickel plating layer 108, which is formed on the first nickel plating layer 107, and a third nickel plating layer 109, which is formed on the second nickel plating layer 108. Additionally, an electroless nickel plating layer or another metal plating layer can be formed on an outer surface of the third nickel plating layer 109.

In one example, the first nickel plating layer 107 is an electroless nickel plating layer. The second nickel plating layer 108 has the first structure. The third nickel plating layer 109 has the second structure. In one example, the first nickel plating layer 107 is an electroless nickel plating layer. The second nickel plating layer 108 has the second structure. The third nickel plating layer 109 has the first structure.

In the third embodiment, in a case of shifting the chain 8 from the second chain ring 62 to the first chain ring 61, the tooth that first engages the chain 8 is illustrated as one of the shifting teeth 75 arranged in the shifting area 71. In another example, the shifting tooth 75 can be a tooth that first engages the chain 8 in a case of shifting the chain 8 from the first chain ring 61 to the second chain ring 62.

For example, a crank assembly can be an assembly that includes the front sprockets 4, 80, 90 of the above embodiments. The crank assembly includes at least one of the front sprockets 4, 80, 90, a pair of crank arms and a crankshaft.

What is claimed is:

1. A bicycle sprocket comprising:
a sprocket body having a rotational center axis; and
a plurality of teeth including a first tooth having a first width extending in a rotational center axis direction, and a second tooth having a second width extending in the rotational center axis direction, the second width being smaller than the first width,
each of the plurality of teeth including a base body and a nickel plating layer, the nickel plating layer covering at least a portion of the base body, and the nickel plating layer including at least one of phosphorus and boron.

2. A bicycle sprocket comprising:
a sprocket body having a rotational center axis; and
a plurality of teeth including a first tooth having a first width extending in a rotational center axis direction, and a second tooth having a second width extending in the rotational center axis direction, the second width being smaller than the first width,
each of the plurality of teeth including a base body and a nickel plating layer, the nickel plating layer covering at least a portion of the base body, and the nickel plating layer including a hard particle.

3. A bicycle sprocket comprising:
a sprocket body having a rotational center axis; and
a plurality of teeth at least partially defining at least one shifting area;
the plurality of teeth including a base body and a nickel plating layer, the nickel plating layer covering at least a portion of the base body, and the nickel plating layer including a hard particle.

4. The bicycle sprocket according to claim 3, wherein
the plurality of teeth includes a shifting tooth disposed in the shifting area, and a driving tooth disposed in an area different from the shifting area, and
the nickel plating layer is formed on at least the driving tooth.

5. The bicycle sprocket according to claim 1, wherein
each of the plurality of teeth includes a side surface facing in the rotational center axis direction, and
the nickel plating layer is formed on the side surface of the first tooth.

6. The bicycle sprocket according to claim 1, wherein
each of the plurality of teeth includes a side surface facing in the rotational center axis direction, and
the nickel plating layer is formed on the side surface of the second tooth.

7. The bicycle sprocket according to claim 2, wherein
the hard particle includes at least one of aluminum oxide and zirconium dioxide.

8. The bicycle sprocket according to claim 2, wherein
the hard particle has an average particle size that is greater than or equal to 0.8 μm.

9. The bicycle sprocket according to claim 2, wherein
the hard particle has an area ratio that is greater than or equal to 10% and less than or equal to 30% with respect to a cross section of the nickel plating layer that is parallel to the rotational center axis direction.

10. The bicycle sprocket according to claim 1, wherein
the base body includes a first layer including a first material, and a second layer including a second material that has a relative density different from a relative density of the first material.

11. The bicycle sprocket according to claim 10, wherein
the relative density of the second material is less than the relative density of the first material, and
the first layer and the second layer are laminated in the rotational center axis direction.

12. The bicycle sprocket according to claim 10, wherein
the first material includes iron, and
the second material includes aluminum.

13. The bicycle sprocket according to claim 10, wherein
the nickel plating layer is formed on an outer surface of the second layer.

14. The bicycle sprocket according to claim 10, wherein
the base body includes a third layer including a third material having a relative density less than the relative density of the first material, and
the first layer is formed between the second layer and the third layer in the rotational center axis direction.

15. The bicycle sprocket according to claim 1, wherein
the nickel plating layer has a Vickers hardness that is greater than or equal to 500 Hv.

16. The bicycle sprocket according to claim 1, wherein the base body includes aluminum.

17. The bicycle sprocket according to claim 1, wherein
each of the plurality of teeth includes a driving surface that transmits driving force to and from a chain, and
the nickel plating layer is formed on the driving surface.

18. The bicycle sprocket according to claim 1, wherein
the nickel plating layer includes at least phosphorus, and
the nickel plating layer has a phosphorus content that is greater than or equal to 0.1 mass percent and less than or equal to 10.0 mass percent.

19. The bicycle sprocket according to claim 18, wherein
the nickel plating layer has a phosphorus content that is greater than or equal to 1.0 mass percent and less than or equal to 5.0 mass percent.

20. The bicycle sprocket according to claim 1, wherein
the nickel plating layer includes at least boron, and
the nickel plating layer has a boron content that is greater than or equal to 0.1 mass percent and less than or equal to 10.0 mass percent.

21. The bicycle sprocket according to claim 20, wherein
the nickel plating layer has a boron content that is greater than or equal to 0.1 mass percent and less than or equal to 2.0 mass percent.

22. The bicycle sprocket according to claim 1, wherein
the nickel plating layer includes electroless nickel plating.

23. The bicycle sprocket according to claim 1, wherein
the nickel plating layer has a thickness that is greater than or equal to 1.0 μm and less than or equal to 100 μm.

24. The bicycle sprocket according to claim 23, wherein
the nickel plating layer has a thickness that is greater than or equal to 5.0 μm and less than or equal to 40.0 μm.

25. The bicycle sprocket according to claim 1, wherein
the sprocket body includes a base body including aluminum, and an alumite coating covering at least a portion of the base body.

26. The bicycle sprocket according to claim 1, wherein
the bicycle sprocket is a single front chain ring.

27. A bicycle sprocket assembly comprising the bicycle sprocket according to claim 1, and the bicycle sprocket assembly further comprising:
a first chain ring including the bicycle sprocket; and
a second chain ring including a further bicycle sprocket that has a smaller diameter than the bicycle sprocket.

28. The bicycle sprocket assembly according to claim 27, wherein
the second chain ring includes a plurality of teeth including a third tooth having a third width in the rotational center axis direction, and a fourth tooth having a fourth width that is smaller than the third width in the rotational center axis direction.

29. The bicycle sprocket assembly according to claim 28, wherein
the third tooth and the fourth tooth each include a base body including aluminum, and an alumite coating covering at least a portion of the base body.

30. The bicycle sprocket assembly according to claim 28, wherein
the third tooth and the fourth tooth each include a base body including aluminum, and electroless nickel plating covering at least a portion of the base body and including at least one of phosphorus and boron.
